(19) United States
(12) Patent Application Publication
(10) Pub. No.: US 2011/0083937 A1
(43) Pub. Date: Apr. 14, 2011

(54) PASSENGER CONVEYOR HANDRAIL DRIVE

(76) Inventors: Changsheng Guo, South Windsor, CT (US); John M. Milton-Benoit, West Suffield, CT (US); John P. Wesson, Vernon, CT (US); JinKoo Lee, Gyeonggi (KR); Sung-Jun Park, Dalian (CN)

(21) Appl. No.: 11/912,324

(22) PCT Filed: Jul. 21, 2005
(86) PCT No.: PCT/US2005/025959

§ 371 Date: Oct. 23, 2007

Related U.S. Application Data
(60) Provisional application No. 60/677,932, filed on May 5, 2005.

(51) Int. Cl. B66B 23/04; B66B 23/24

(52) U.S. Cl. 198/335

(57) ABSTRACT

A passenger conveyor (20) includes a handrail drive (40) for propelling a handrail (30). A suspension (100) associated with the drive (40) supports a weight of a corresponding portion of the handrail (30) in the vicinity of the drive device (40). In a disclosed example, the suspension (100) includes at least one cantilevered member (104, 120) for engaging a lip portion (64) of an inner surface on the handrail (30). The suspension (100) maintains a corresponding portion of the handrail (30) in close proximity to a drive member (42) such as a toothed belt to ensure proper engagement between the drive member (42) and the handrail (30).

### 1. FIELD OF THE INVENTION

This invention generally relates to passenger conveyors. More particularly, this invention relates to a device for driving a handrail of a passenger conveyor.

### 2. DESCRIPTION OF THE RELATED ART

Passenger conveyors have proven effective for carrying people between different levels within a building or across an elongated pathway, for example. Typical arrangements include a plurality of steps or a belt upon which an individual stands to be carried from one location to another. A handrail typically rides over a balustrade and provides a surface for an individual to grab onto for stabilizing themself. Typical handrail configurations have a generally flat surface oriented parallel to the ground or the direction of movement of the conveyor (i.e., on an angle relative to vertical along the rise of an escalator).

Handrails are driven to move in unison with the steps or moving belt. A handrail drive mechanism causes the desired movement of the handrail. There are various shortcomings and drawbacks with conventional handrail drive systems. Typical arrangements rely upon pinching rollers that engage oppositely facing sides of the handrail to generate enough friction to drive the handrail in the desired direction.

One problem with conventional driving arrangements is that the pinching rollers engage the gripping surface side of the handrail. This tends to scratch and cause wear in the gripping surface. This results in eventual replacement of a handrail at a time that is earlier than desired. It would be useful to be able to extend the life of a handrail.

Another shortcoming of conventional arrangements is that there is a “friction contradiction” introduced by the need to generate enough friction to move the handrail and a need to allow the handrail to readily slide along a guidance to follow the balustrade. The same surface that needs to be able to easily slide along the guidance is typically engaged by the driving mechanism, which uses friction to engage that surface and propel the handrail.

Additionally, the friction caused by the pinching rollers in the drive mechanism tends to wear the fabric layer used for sliding the handrail along the balustrade. As this fabric layer becomes worn, the handrail eventually cannot operate as desired and requires repair or replacement. At the same time, the presence of the lower friction material requires higher pinching forces on the handrail, which tends to more rapidly cause wear on the gripping surface, which introduces earlier replacement.

A variety of alternative arrangements have been proposed. One early example toothed belt is shown in U.S. Pat. No. 3,749,224, which is used for driving a handrail. The Japanese patent publication 2735453 shows another toothed belt for engaging a correspondingly toothed surface on a handrail. One shortcoming of the arrangement shown in that document is that there is a tendency for vertical separation forces to interfere with desired engagement between the driving belt and the handrail. One example embodiment in that document includes rollers to counteract these vertical separation forces. The presence of rollers against the gripping surface still introduces possible wear on the gripping surface. Alternative driving arrangements are shown in the published applications WO 03/066500 and WO 2004/035451. Other arrangements including a drive belt for moving a handrail are shown in U.S. Pat. Nos. 5,117,960 and 5,307,920.

Despite the publication of these various alternatives, the majority of passenger conveyor installations include the traditional pinching roller drive arrangement. There is a need for an improved handrail drive that avoids the friction contradiction mentioned above, avoids introducing undesirable wear on a gripping surface and maintains sufficient engagement between the handrail and the drive mechanism, which is not compromised by vertical separation forces introduced between a drive belt and a handrail, for example.

This invention addresses those needs.

### SUMMARY OF THE INVENTION

This invention includes a unique suspension for supporting a handrail in a manner to facilitate engagement with a drive member while avoiding undesirable contact with the passenger gripping surface.

An exemplary device for propelling a passenger conveyor handrail includes a drive member for engaging a first portion of an inner surface on a handrail to move the handrail in a desired direction. A suspension near the drive member suspends the handrail from another portion of the inner surface to facilitate engagement between the handrail and the drive member.

One example suspension includes at least one cantilevered member that engages the inner surface of the handrail. In one example, the cantilevered member comprises a generally planar member along which the inner surface of the handrail slides. In another example, the cantilevered member comprises at least one roller.

An exemplary passenger conveyor handrail assembly includes a handrail having a driven surface including a plurality of teeth and a lip near the teeth. A drive member engages the plurality of teeth on the handrail driven surface for moving the handrail in a desired direction. A suspension near the drive member suspends the handrail from the lip to facilitate engagement between the handrail teeth and the drive member.

An exemplary disclosed passenger conveyor system includes a handrail having an outer surface that provides a passenger gripping surface. The handrail also includes an inner surface. A guidance supports the handrail from the inner surface along a portion of a loop traveled by the handrail that corresponds to a distance traveled by a passenger on the conveyor. A drive member engages the inner surface of the handrail for moving the handrail in a desired direction about the loop. An inverted guidance near the drive member suspends a corresponding portion of the handrail from the inner surface along another portion of the loop, which corresponds to a portion engaged by the drive member.

The various features and advantages of this invention will become apparent to those skilled in the art from the following description of a currently preferred embodiment. The drawings that accompany the detailed description can be briefly described as follows.

### BRIEF DESCRIPTION OF THE DRAWINGS

FIG. 1 schematically shows selected portions of an example passenger conveyor including a handrail driving device designed according to an embodiment of this invention.

FIG. 2 schematically shows selected portions of an example drive belt and an example handrail.

FIG. 3 is a cross-sectional view taken along the lines 3-3 in FIG. 1, which schematically shows an example configuration of a handrail and a cooperating guidance.

FIG. 4 schematically shows an example handrail driving device including a suspension designed according to an embodiment of this invention.

FIG. 5 is a cross-sectional view taken along the lines 5-5 in FIG. 4.

FIG. 6 is a perspective, diagrammatic view of a suspension from the embodiment of FIG. 4.

FIG. 7 is an illustration similar to the illustration of FIG. 5 showing another example embodiment of a suspension.

### DETAILED DESCRIPTION

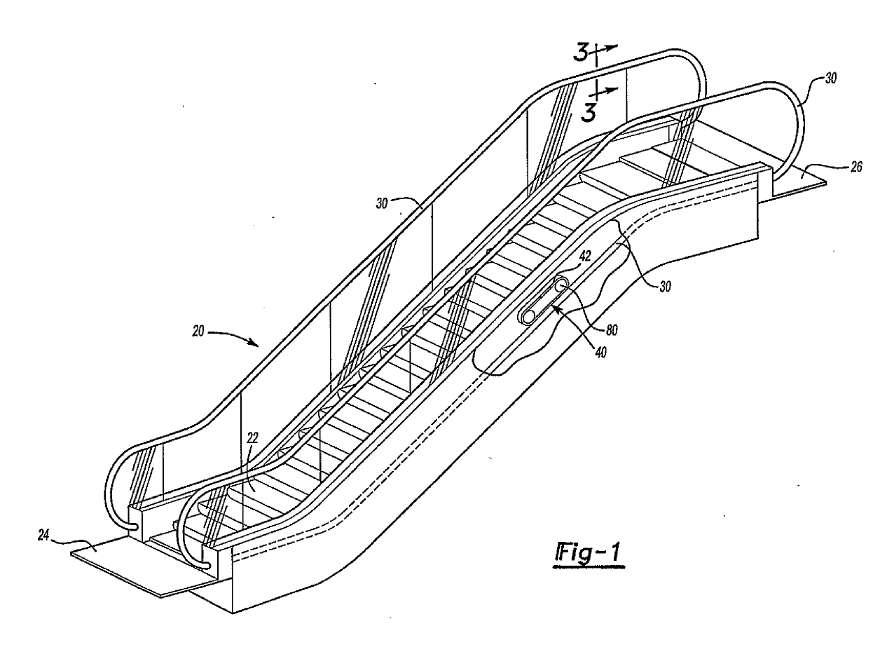

FIG. 1 schematically shows a passenger conveyor 20. In this example, the passenger conveyor is an escalator having a plurality of steps 22 for carrying passengers between landings 24 and 26 at different levels within a building. This invention is not limited to escalators but is also applicable to other forms of passenger conveyors such as moving walkways, for example.

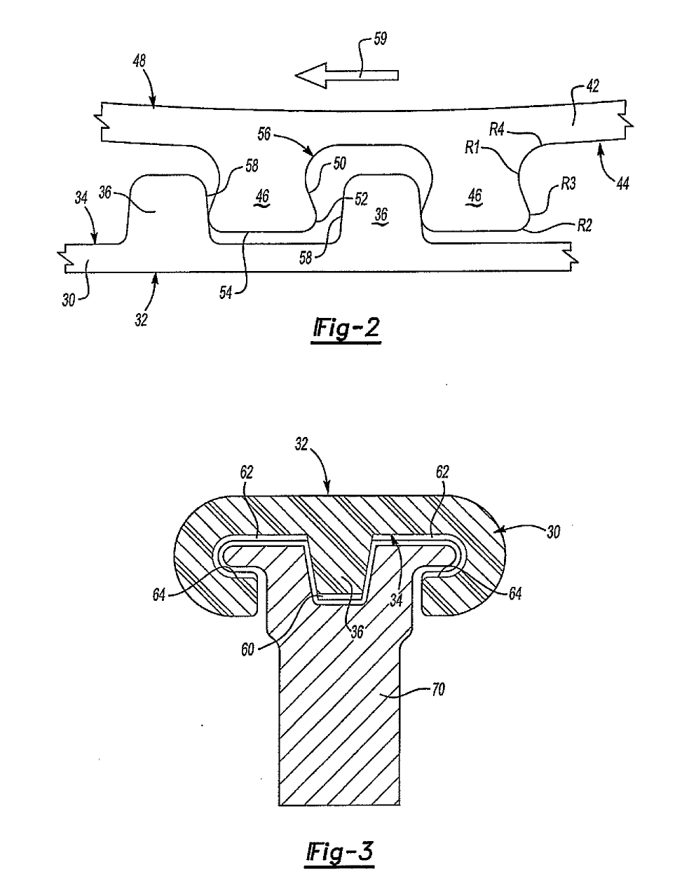

The example passenger conveyor of FIG. 1 includes a handrail 30 that moves along with the steps 22 that can be grasped by a passenger on the conveyor to stabilize themself, for example. FIG. 2 schematically shows one example handrail 30 having an outer surface 32 facing generally upward in the view of FIG. 1. The example outer surface 32 provides a gripping surface for a passenger to grasp. In the view of FIG. 2, which corresponds to the broken away portion of FIG. 1, the outer surface 32 faces downward because the handrail is following along the so-called return portion of the handrail loop.

The handrail 30 also includes a driven or inner surface 34 having a plurality of teeth 36. A handrail drive device 40 includes a drive belt 42 having a driving surface 44 including a plurality of teeth 46 that cooperate with the teeth 36 on the handrail 30 to propel the handrail in a desired direction. In this sense, the illustrated arrangement is a linear positive drive arrangement.

The teeth 46 in the illustrated example have a unique configuration that facilitates proper engagement between the drive belt teeth 46 and the handrail teeth 36. Each tooth 46 includes a generally concave portion 50 along an engaging surface that contacts or engages a corresponding surface on the handrail teeth 36. The example teeth 46 include generally convex projections 52 near an end 54 of each tooth 46, which is distal from a base portion 56.

The example tooth configuration including at least the concave portion 50 facilitates better engagement between the drive belt teeth 46 and the handrail teeth 36. The concave portion 50 along at least a portion of the engaging surface minimizes or eliminates vertical separation forces that otherwise tend to cause the handrail teeth 36 to move away from the drive belt 42 when the handrail 30 is being driven. The projections 52 also facilitate minimizing or eliminating vertical separation forces because they provide an at least slightly deformable leading edge to distribute forces associated with engagement between the teeth 46 and the teeth 36. This further enhances the ability for the example arrangement to avoid vertical separation forces.

In one example, the handrail 30 and the drive belt 42 both comprise a thermoplastic polyurethane material and the illustrated geometric configuration avoids clashing between the teeth associated with engagement between them.

Another feature of the example of FIG. 2 is a low friction material 60 near an end of each of the handrail teeth 36. In one example, the low friction material comprises a known fabric used for a slider layer in passenger conveyor handrails. One example includes a Polyoxymethylene (POM) material.

As can be appreciated from FIG. 3, the low friction material 60 on the end of each tooth 36 and a low friction material 62 on the inner surface 34 side of a lip 64 near the teeth 36 facilitates the handrail 30 sliding along a guidance 70 in a generally known manner.

The illustrated example arrangement avoids the so-called friction contradiction experienced with previous handrail and handrail drive designs. At the same time, the illustrated example still provides the advantage of utilizing a low friction material for sliding the handrail 30 along a guidance 70. The disclosed example achieves the dual purposes of having a well-driven handrail that readily slides along a guidance because the teeth 46 and 36 interact without involving the low friction material 60 on the ends of the teeth 36.

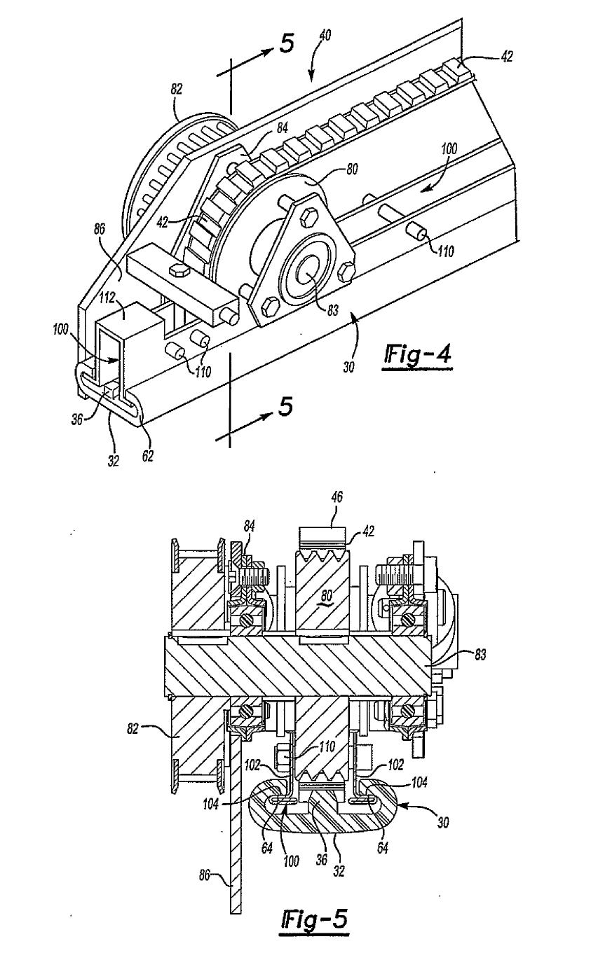

Referring to FIGS. 4-6, an example drive device 40 includes the drive belt 42. A drive wheel 80 propels the belt 42 around a belt loop such that the belt 42 engages a portion of the handrail 30 along the return portion of the handrail loop. In this example, the drive wheel 80 rotates with another wheel 82 that is associated with movement of the steps of the conveyor 20. In the illustrated example, the drive wheel 80 and the wheel 82 rotate together with an axle 83.

A drive wheel support 84 allows the drive wheel 80 to rotate responsive to an appropriate motive force. In this example, the drive wheel support 84 is secured to a support wall 86 that is associated with the passenger conveyor truss in a manner that provides a stable placement of the drive wheel 80, for example.

Because the belt 42 engages the handrail 30 along the return portion of the handrail loop, gravity may tend to urge the handrail 30 away from the drive belt 42 in a manner that interferes with desired engagement between the teeth 46 and 36. The illustrated example includes a suspension 100 that suspends a corresponding portion of the handrail 30 in the vicinity of the drive belt 42 to ensure proper engagement between the teeth 46 and 36, for example.

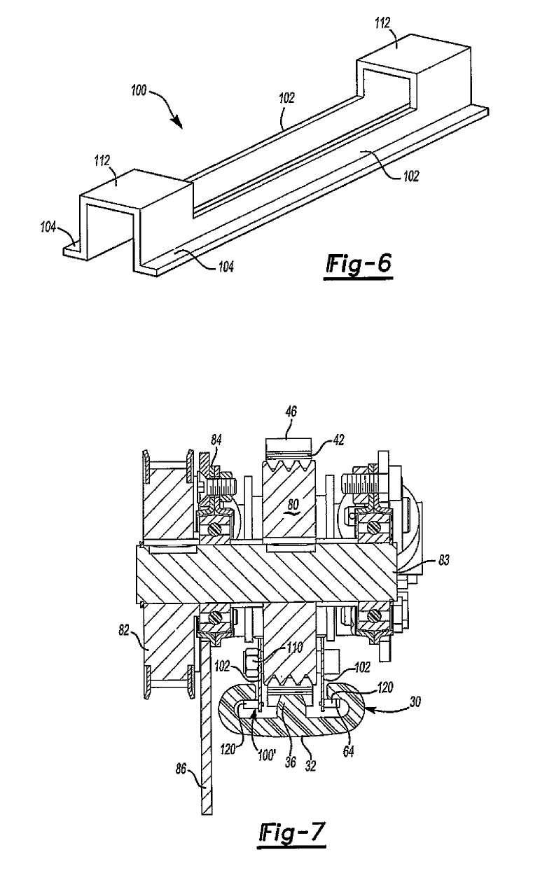

In the illustrated example, the suspension 100 includes spaced apart supports 102 that are positioned on opposite sides of the belt 42 and the drive wheel 80. At least one cantilevered member extends from each of the supports 102 for engaging the lip 64 on the inner surface 34 of the handrail 30. In the example of FIGS. 5 and 6, the cantilevered member comprises a generally planar, elongated support surface 104 along which the lip 64 slides as the handrail 30 moves responsive to operation of the drive device 40. Having a slider material on the lip 64 facilitates such movement in one example.

As best appreciated from FIG. 4, the example suspension 100 includes a plurality of spacers 110 that extend across spacing or channel between the supports 102 and provides stability and rigidity to the suspension arrangement. In this example, the spacers 110 comprise threaded members that are secured in place. In this example, the drive belt 42 is received between the spacers 110 and the driven surface 34 of the handrail 30 as can be appreciated from FIGS. 4 and 5, for example.

As can be appreciated from FIGS. 4 and 6, ends of the suspension 100 are positioned outside of the area of engagement between the drive belt 42 and the handrail 30. In this example the ends include spacers 112 that comprise plates extending between the supports 102.

In one example, as shown in FIG. 6, the suspension 100 includes a single piece of metal formed into the shape shown in FIG. 6. As shown in the example of FIG. 5, one end of a metal plate or sheet can be bent into a configuration to establish the cantilevered support surfaces 104. Those skilled in the art who have the benefit of this description will be able to select an appropriate material and an appropriate technique for forming a suspension that operates consistent with the illustrated example.

Another example suspension 100′ is shown in FIG. 7. In this example, the supports 102 support a plurality of rollers 120 that are effectively cantilevered from the supports 102. In this example, the rollers 120 support the weight of the handrail 30 along a corresponding portion of the handrail as the rollers 120 engage the lip 64 on the inner surface 34 of the handrail 30. In one example, the rollers 120 rotate responsive to movement of the handrail, which is caused by the drive device 40. One example includes needle style rollers. In one example, a plurality of rollers are spaced along a length of the suspension 100′ that corresponds to a length of engagement between the drive device 40 and the handrail 30.

As can be appreciated from considering FIGS. 3, 4 and 5, the example passenger conveyor includes a guidance 70 that supports the handrail 30 from the inner surface 34 along a portion of the handrail loop that corresponds to the distance traveled by a passenger utilizing the conveyor. The example guidance 70 supports the handrail 30 in this manner along the portion of the loop where the exterior surface 32 providing a gripping surface is exposed for use by a passenger. The suspension 100 in one example comprises an inverted guidance along at least some of the return portion of the loop followed by the handrail 30. The inverted guidance or suspension 100 supports the weight of a corresponding portion of the handrail 30 from the inner surface 34. In the illustrated example, the inverted guidance or suspension 100 engages the lip 64 for supporting the weight of at least the corresponding portion of the handrail 30.

The illustrated examples provide the significant advantage of avoiding contact between the gripping surface 32 of the handrail 30 while still facilitating proper engagement between the handrail 30 and the example drive belt 42. Eliminating the presence of pinching rollers and avoiding contact with the gripping surface as provided by the illustrated examples significantly improves the appearance of a handrail and extends the useful life of a handrail because there is much less wear on the exterior surface.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A device for propelling a passenger conveyor handrail, comprising:
a drive member for engaging a first portion of an inner surface on a handrail to move the handrail in a desired direction; and
a suspension near the drive member for suspending the handrail from another portion of the inner surface to facilitate engagement between the handrail and the drive member.

2. The device of claim 1, wherein the suspension comprises at least one cantilevered member that engages the inner surface.

3. The device of claim 2, wherein the suspension comprises at least two cantilevered members spaced apart a distance corresponding to a width of the drive member and wherein the cantilevered members are positioned on opposite sides of the drive member.

4. The device of claim 3, wherein the drive member comprises a belt that engages the handrail along a length of the belt and wherein the cantilevered members each engage the inner surface along a length corresponding to the length of the belt.

5. The device of claim 4, including support members from which the cantilevered members extend, respectively, and wherein the belt is received at least partially between the support members.

6. The device of claim 2, wherein the cantilevered member comprises a generally planar support arm.

7. The device of claim 2, wherein the cantilevered member comprises a roller.

8. The device of claim 7, including a plurality of rollers.

9. The device of claim 1, wherein the suspension comprises at least one elongated member having a first generally planar portion supported in a fixed position relative to the drive member and a second portion extending away from the first portion for receiving the other portion of the handrail inner surface.

10. A passenger conveyor handrail assembly, comprising:
a handrail having a driven surface including a plurality of teeth and a lip near the teeth;
a drive member that engages the plurality of teeth on the handrail driven surface for moving the handrail in a desired direction; and
a suspension near the drive member that suspends the handrail from the lip to facilitate engagement between the handrail teeth and the drive member.

11. The assembly of claim 10, wherein the suspension comprises at least one cantilevered member.

12. The assembly of claim 11, wherein the lip slides along a portion of the cantilevered member as the drive member moves the handrail.

13. The assembly of claim 11, wherein the suspension comprises at least one roller that rotates responsive to contact with the lip as the handrail moves responsive to the drive member.

14. The assembly of claim 10, wherein the suspension engages the lip along a length of the handrail corresponding to an amount of engagement between the drive member and the handrail and wherein the suspension supports a weight of at least the portion of the handrail along the length.

15. The assembly of claim 10, wherein the drive member comprises a toothed belt that engages the teeth on the handrail driven surface and wherein the belt is received within a channel of the suspension.

16. The assembly of claim 15, wherein the suspension comprises a first support on one side of the belt and a second support on an opposite side of the belt.

17. The assembly of claim 16, including at least one spacer extending across a space between the first and second supports and wherein the belt is at least partially arranged between the at least one spacer and the handrail.

18. A passenger conveyor system, comprising:
a handrail having an outer surface that provides a passenger gripping surface and an inner surface;
a guidance that supports the handrail from the inner surface along a portion of a loop traveled by the handrail that corresponds to a distance traveled by a passenger on the conveyor;
a drive member that engages the inner surface of the handrail for moving the handrail in a desired direction about the loop; and
an inverted guidance near the drive member that suspends a corresponding portion of the handrail from the inner surface along another portion of the loop.

19. The system of claim 18, wherein the handrail inner surface comprises a plurality of teeth and a lip near the teeth and the inverted guidance engages the lip for supporting a weight of the corresponding portion of the handrail.

20. The system of claim 19, including a channel through the inverted guidance and wherein the drive member comprises a belt that is at least partially received within the channel.
